(19) United States
(12) Patent Application Publication
(10) Pub. No.: US 2010/0202258 A1
(43) Pub. Date: Aug. 12, 2010

(54) Optical Disk Drive and Operation Method Thereof

(76) Inventors: Jun Ho Huh, Yongin-si (KR); Je Kook Kim, Yongin-si (KR)

Correspondence Address: F. CHAU & ASSOCIATES, LLC, 130 WOODBURY ROAD, WOODBURY, NY, 11797, US

(21) Appl. No.: 12/389,870

(22) Filed: Feb. 20, 2009

(30) Foreign Application Priority Data
Feb. 6, 2009 (KR) 10-2009-0009633

(51) Int. Cl. G11B 7/00

(52) U.S. Cl. 369/44.32

(57) ABSTRACT

An optical disk drive includes a pickup apparatus and a servo error correction unit. The pickup apparatus reads data recorded on an optical disk or records encoded data on the optical disk. The pickup apparatus includes a servo control unit. The servo error correction unit generates, based upon data read by the pickup apparatus, a tilt control signal to correct the tilt of the pickup apparatus generated as a result of the eccentricity of the optical disk and the tilt of the optical disk,. The servo control unit of the pickup apparatus controls the tilt of the optical disk and the tilt of the pickup apparatus in response to the tilt control signal.

### CROSS-REFERENCE TO RELATED APPLICATION

This application claims priority to and the benefit of Korean Patent Application No. 10-2009-0009633 filed on 6 Feb. 2009 in the Korean Intellectual Property Office, the entire content of which is incorporated herein by reference.

### BACKGROUND

1. Field of the Invention

The present invention relates to an optical disk drive, and more particularly, to an optical disk drive capable of correcting tilt of a pickup apparatus generated as a result of the eccentricity of an optical disk during the operation of an optical disk drive, and a method of operating the optical disk drive.

2. Description of the Related Art

In general, optical disk drives write data to an optical disk or read data from the optical disk using a pickup apparatus moving along a track of the optical disk that is a groove formed in the surface of the optical disk. The optical disk drive generates a tracking error control signal for correcting a tracking error, a focusing control signal for correcting a focusing error, and a tilt control signal for correcting tilt, using a radio frequency (RF) signal from a head of the pickup apparatus. In a conventional optical disk drive, tilt control maintains a light reflection angle at a right angle in all areas of the optical disk by reflecting the difference in light reflection angle between the inner circumference and the outer circumference of the optical disk, that is, the amount of tilt of the optical disk.

However, in addition to the tilt of the optical disk, tilt may be generated by the operation of the optical disk drive. In more detail, a narrow space exists between the shaft of a spindle motor of the optical disk drive and the optical disk. When the spindle motor rotates, eccentricity is generated as a result of the space when the optical disk moves left and right. Accordingly, the pickup apparatus may be tilted as a result of the tracking operation of the pickup apparatus.

The tilt of the pickup apparatus generated as a result of the eccentricity of the optical disk may generate distortion of the RF signal that is output from the head at the same frequency as a rotation frequency of the spindle motor. Such a phenomenon is referred to as an RF drop and may increase errors in the read/write operation of the optical disk drive.

### SUMMARY

Exemplary embodiments of the present invention provide an optical disk drive capable of correcting tilt of a pickup apparatus generated as a result of the eccentricity of an optical disk during the operation of an optical disk drive such that accurate read/write operation may be performed. An exemplary method of operating the optical disk drive is also provided.

According to an exemplary embodiment of the present invention, there is provided an optical disk drive which includes a pickup apparatus and a servo error correction unit. The pickup apparatus reads data recorded on an optical disk or records encoded data on the optical disk. The pickup apparatus includes a servo control unit. The servo error correction unit generates, based upon data read by the pickup apparatus, a tilt control signal to correct the tilt of the pickup apparatus generated as a result of the eccentricity of the optical disk and the tilt of the optical disk. The servo control unit of the pickup apparatus, in response to the tilt control signal, controls the tilt of the optical disk and the tilt of the pickup apparatus.

The servo error correction unit may include a first tilt correction circuit and a second tilt correction circuit. The first tilt correction circuit corrects the tilt of the optical disk. The second tilt correction circuit corrects the tilt of the pickup apparatus generated as a result of the eccentricity of the optical disk.

### BRIEF DESCRIPTION OF THE DRAWINGS

FIG. 1 is a block diagram of an optical disk drive according to an exemplary embodiment of the present invention.

FIG. 2A illustrates the generation of tilt of a pickup apparatus as a result of the eccentricity of an optical disk in the optical disk drive of FIG. 1.

FIG. 2B illustrates the correction of the tilt of a pickup apparatus as a result of the eccentricity of the optical disk in the optical disk drive of FIG. 1.

FIG. 3 is a block diagram of a servo error correction unit and the pickup apparatus of FIG. 1.

FIG. 4 is a circuit diagram of the servo error correction circuit of FIG. 1.

FIG. 5 is a flowchart for explaining a method of operating an optical disk drive according to an exemplary embodiment of the present invention.

FIG. 6A is a graph showing an RF signal read by a pickup apparatus of an optical disk drive according to a comparative example.

FIG. 6B is a graph showing an RF signal read by a pickup apparatus of an optical disk drive according to an exemplary embodiment of the present invention.

### DETAILED DESCRIPTION OF THE EMBODIMENTS

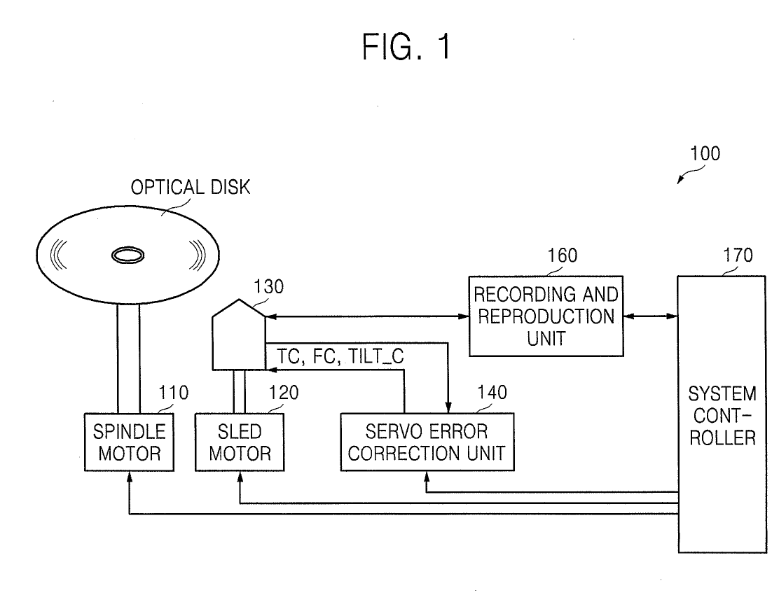

Referring to FIG. 1, the optical disk drive 100 includes a spindle motor 110, a sled motor 120, a pickup apparatus 130, a servo error correction unit 140, a recording and reproduction unit 160, and a system controller 170.

An optical disk is rotated by being loaded on a rotation shaft of the spindle motor 110. The pickup apparatus 130 may be moved left and right as a result of the rotation of the sled motor 120. The sled motor 120 may move the pickup apparatus 130 left and right. The optical disk may be a compact disc (CD) drive, a digital video disc (DVD) drive, or blu-ray disc (BD) drive. However, the embodiments of the present invention are not limited thereto.

The pickup apparatus 130 writes encoded data to the optical disk or reads data recorded on the optical disk. When reading the data recorded on the optical disk, the pickup apparatus 130 generates and outputs an RF signal using an optical element (not shown).

The servo error correction unit 140 corrects a tracking error, a focusing error, and tilt of the pickup apparatus 130 based upon the data read by the pickup apparatus 130. The term “tracking” signifies moving a head (not shown) including a lens left and right in the pickup apparatus 130 to a target track of the optical disk. The term “focusing” signifies moving the head up and down in the pickup apparatus 130 to focus light received from the optical disk. The term “tilt” signifies inclination of the pickup apparatus 130 left and right with respect to a central shaft.

There are two types of tilt of the pickup apparatus 130. The first tilt type of the pickup apparatus 130 is tilt that results from distortion of a surface of an optical disk, that is, optical disk tilt. To correct the optical disk tilt the optical pickup apparatus 130 is tilted to maintain the light reflection angle with respect to the overall surface of the optical disk at a right angle for an accurate recording and reproduction operation.

The second tilt type of the pickup apparatus 130 is tilt that results from the eccentricity of the optical disk. The eccentricity of the optical disk occurs when the optical disk is rotated left and right due to a narrow space existing between the shaft of the spindle motor 110 and the optical disk when the spindle motor 110 rotates.

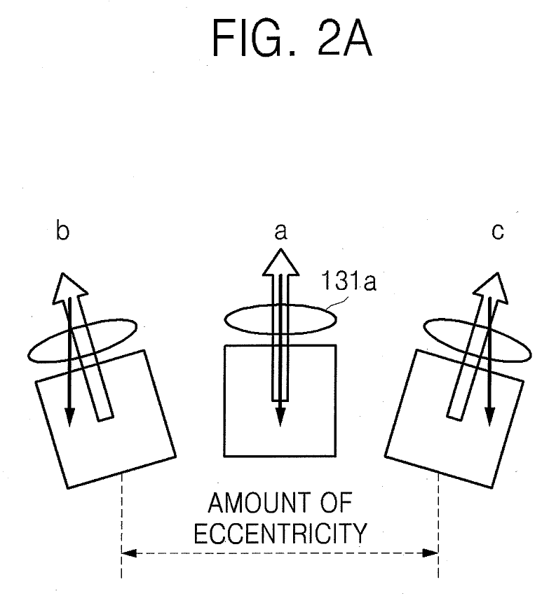

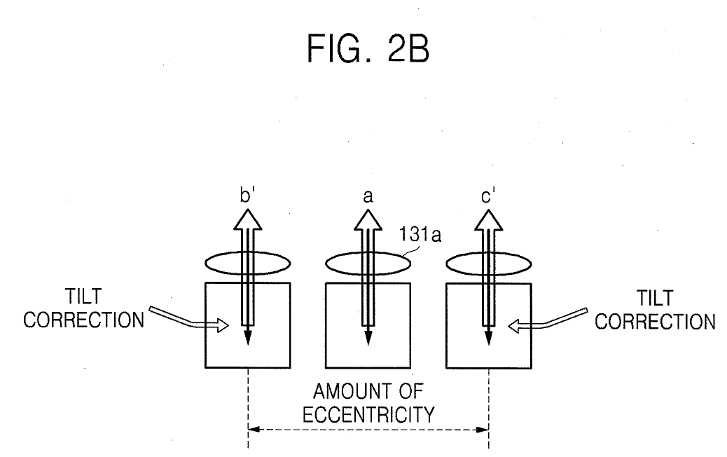

When the eccentricity of the optical disk is generated, the pickup apparatus 130 may be tilted due to the tracking operation of the pickup apparatus 130. FIG. 2A illustrates that the pickup apparatus 130 is tilted due to the eccentricity generated during the rotation of an optical disk in the optical disk drive 100 of FIG. 1. In FIG. 2A, the pickup apparatus 130 includes a lens 131a having an oval shape.

Referring to FIG. 2A, it can be seen, that the pickup apparatus 130 is not tilted in a state a in which the eccentricity is not generated in the optical disk. By contrast, in the states b and c in each of which the eccentricity is generated in the optical disk, the pickup apparatus 130 is tilted for the same position of the optical disk. The tilt of the pickup apparatus 130 indicates that the head of the pickup apparatus 130 is inclined left and right with respect to the central shaft. The tilt according to the eccentricity of the optical disk increases in proportion to the amount of eccentricity of the pickup apparatus 130 and is generated at the same frequency as the rotation frequency of the spindle motor 110.

The tilt of the pickup apparatus 130 generated based upon the eccentricity of the optical disk generates distortion of the RF signal output from the head, that is, an RF drop, at the same frequency of the rotation frequency of the spindle motor 110. The RF drop degrades the accuracy in the recording and reproduction operation of the optical disk drive 100.

In the optical disk drive 100 according to an exemplary embodiment of the present invention, the accuracy in the recording and reproduction operation is improved because the tilt of the pickup apparatus 130 generated due to the eccentricity of the optical disk is corrected.

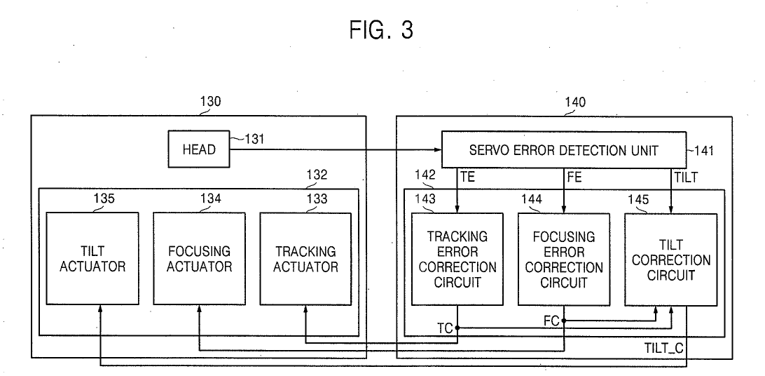

FIG. 2B illustrates the correction of the tilt of the pickup apparatus 130 generated as a result of the eccentricity of an optical disk in the optical disk drive 130 of FIG. 1. Referring to FIG. 2B, it can be seen that the tilt of the pickup apparatus 130 is corrected in states b′ and c′ in which the eccentricity of the optical disk is generated. The tilt correction operation of the pickup apparatus 130 generated due to the eccentricity of the optical disk of the optical disk drive 100 is described in more detail with reference to FIGS. 3-6B.

The servo error correction unit 140 generates a tracking control signal TC, a focusing control signal FC, and a tilt control signal TILT_C based upon the data read by the pickup apparatus 130. Then, a servo control unit (not shown) included in the pickup apparatus 130 corrects the tracking error, the focusing error, and the tilt in response to the tracking control signal TC, the focusing control signal FC, and the tilt control signal TILT_C.

The recording and reproduction unit 160 encodes data to be recorded on the optical disk or decodes data read by the optical disk. The system controller 170 controls the operations of the spindle motor 110, the sled motor 120, the servo error correction unit 140, and the recording and reproduction unit 160.

FIG. 3 is a block diagram of the pickup apparatus 130 and the servo error correction unit 140 of FIG. 1. The pickup apparatus 130 includes a head 131 and a servo control unit 132. The servo error correction unit 140 includes a servo error detection unit 141 and a servo error correction circuit 142.

The servo control unit 132 corrects the tracking error, the focusing error, and tilt in response to the tracking control signal TC, the focusing control signal FC, and the tilt control signal TILT_C, respectively. The servo control unit 132 includes a tracking actuator 133, a focusing actuator 134, and a tilt actuator 135. The tracking actuator 133 corrects the tracking error TE of the pickup apparatus 130 by moving the head 131 left and right in the pickup apparatus 130 in response to the tracking control signal TC.

The focusing actuator 134 corrects the focusing error FE of the pickup apparatus 130 by moving the head 131 up and down in the pickup apparatus 130, in response to the focusing control signal FC. The tilt actuator 135 corrects tilt of the pickup apparatus 130 generated due to the eccentricity of the optical disk and the optical disk tilt, in response to the tilt control signal TILT_C.

In the servo error correction unit 140, the servo error correction circuit 142 includes a tracking error correction circuit 143, a focusing error correction circuit 144, and a tilt correction circuit 145. The servo error detection unit 141 detects the tracking error TE, the focusing error FE, and an optical disk error TILT of the pickup apparatus 130 based upon the data read by the head 131.

The tracking error correction circuit 143 receives the tracking error TE and generates the tracking control signal TC to correct the tracking error TE. The focusing error correction circuit 144 receives the focusing error FE and generates the focusing control signal FC to correct the focusing error FE. The tilt correction circuit 145 receives the optical disk tilt TILT and receives the focusing control signal FC or the tracking control signal TC.

The tilt correction circuit 145 corrects the optical disk tilt TILT received from the servo error detection unit 141. Also, the tilt correction circuit 145 corrects the tilt of the pickup apparatus 130 generated as a result of the eccentricity of the optical disk based upon the focusing control signal FC or the tracking control signal TC.

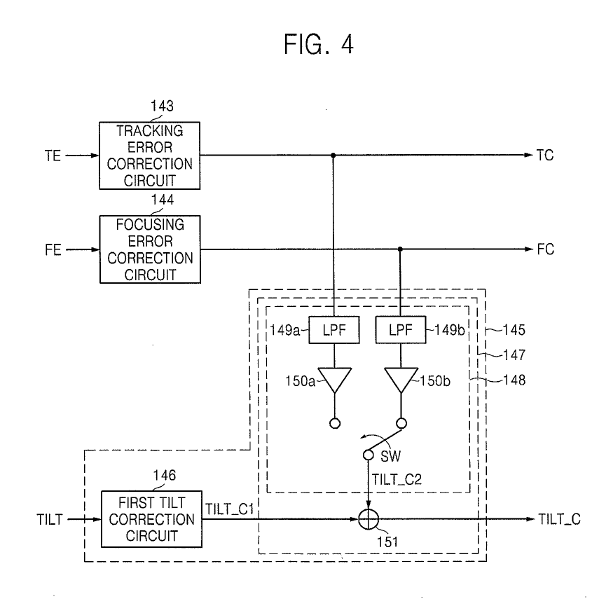

FIG. 4 is a circuit diagram of the servo error correction circuit 140 of FIG. 1. It can be seen that the servo error correction circuit 140 includes tracking error correction circuit 143 and the focusing error correction circuit 144.

The tracking error correction circuit 143 equalizes the tracking error TE based upon the operational frequency of the optical disk drive 100 to generate the tracking control signal TC. The focusing error correction circuit 144 equalizes the focusing error FE based upon the operational frequency of the optical disk drive 100 to generate the focusing control signal FC.

The tilt correction circuit 145 includes a first tilt correction circuit 146 and a second tilt correction circuit 147. The first tilt correction circuit 146 corrects the tilt TILT of the optical disk. The second tilt correction circuit 147 corrects the tilt of the pickup apparatus 130 generated due to the eccentricity of the optical disk.

The first tilt correction circuit 146 generates a first tilt control signal TILT_C1 to correct the tilt TILT of the optical disk. The second tilt correction circuit 147 generates a second tilt control signal TILT_C2 to correct the tilt generated due to the eccentricity of the optical disk based upon the tracking error TE of the pickup apparatus 130. Also, the second tilt correction circuit 147 generates the second tilt control signal TILT_C2 to correct the tilt generated due to the eccentricity of the optical disk based upon the focusing error FE of the pickup apparatus 130.

The second tilt correction circuit 147 includes a tilt control signal generation unit 148 and an adder 151. The tilt control signal generation unit 148 generates the second tilt control signal TILT_C2 based upon the tracking error TE. Also, the tilt control signal generation unit 148 generates the second tilt control signal TILT_C2 based upon the focusing error FE.

In FIG. 4, the second tilt control signal TILT_C2 is generated based upon the tracking error TE or the focusing error FE by the switching operation of a switch SW. However, embodiments of the present invention are not limited thereto. For example, the tilt control signal generation unit 148 may complete only a circuit generating the second tilt control signal TILT_C2 based upon the tracking control signal TC or only a circuit generating the second tilt control signal TILT_C2 based upon the focusing control signal FC.

The adder 151 generates the tilt control signal TILT_C by adding the first and second tilt control signals TILT C1, TILT_C2. Then, the tilt actuator 135 of the pickup apparatus 130 shown in FIG. 3 controls the tilt of the head 131 included in the pickup apparatus 130, in response to the tilt control signal TILT_C. Thus, the tilt of the pickup apparatus 130 generated due to both the optical disk tilt TILT and the eccentricity of the optical disk is corrected.

Still referring to FIG. 4, the tilt control signal generation unit 148 includes a first low pass filter (LPF) 149a, a first amplifier 150a, a second LPF 149b, a second amplifier 150b, and the switch SW. The first LPF 149a filters the tracking control signal TC to correct the tracking error TE and extracts a rotation frequency signal of the optical disk. The first LPF 149a also low pass filters noise of the optical disk.

The rotation frequency signal of the optical disk includes information about the tilt of the pickup apparatus 130 generated due to the eccentricity of the optical disk. This is because the tilt of the pickup apparatus 130 generated due to the eccentricity of the optical disk is generated at the same frequency as the rotation frequency of the optical disk. Thus, the tilt of the pickup apparatus 130 generated due to the eccentricity of the optical disk may be corrected by the same frequency as the rotation frequency of the optical disk.

The first amplifier 150a generates the second tilt control signal TILT_C2 by multiplying the rotation frequency signal of the optical disk output from the first low pass filter 149a by a gain value. The gain value multiplied to the rotation frequency signal of the optical disk may be predetermined in proportion to the tilt of the pickup apparatus 130 generated due to the eccentricity of the optical disk.

The eccentricity of the optical disk is generated due to the narrow space between the shaft of the spindle motor 110 and the optical disk. The tilt of the pickup apparatus 130 is generated by the reciprocation of the pickup apparatus 130 according to the eccentricity of the optical disk. Thus, the gain value may be predetermined according to the narrow space between the shaft of the spindle motor 110 and the optical disk, the rotation frequency of the optical disk, and the relationship between the inertia according to the reciprocation of the head 131 and the tilt amount of the pickup apparatus 130.

The rotation frequency signal of the optical disk may be extracted from the focusing control signal FC. This is because the optical disk rotated by being loaded on the shaft of the spindle motor 110 moves not only left and right but also up and down at the rotation frequency of the spindle motor 110. Also, the signal correcting the up and down operation of the optical disk at the rotation frequency of the optical disk is the focusing control signal FC.

The circuit generating the second tilt control signal TILT_C2 from the focusing control signal FC includes the second low pass filter 149b and the second amplifier 150b, similar to the circuit generating the second tilt control signal TILT_C2 from the tracking control signal TC. In the second amplifier 150b, the process of obtaining the gain value multiplied to the rotation frequency of the optical disk is the same as that described for the operation of the circuit generating the second tilt control signal TILT_C2 using the tracking control signal TC.

The switch SW selectively outputs the second tilt control signal TILT_C2 generated based upon the focusing control signal FC or the second tilt control signal TILT_C2 generated based upon the tracking control signal TC. The adder 151 adds the first tilt control signal TILT_C1 to correct the optical disk tilt and the second tilt control signal TILT_C2 to correct the tilt of the pickup apparatus 130 generated due to the eccentricity of the optical disk, thereby outputting the tilt control signal TILT_C. Then, the tilt actuator 135 of the pickup apparatus 130, in response to the tilt control signal TILT_C, corrects the tilt of the pickup apparatus 130 generated due to the eccentricity of the optical disk and the optical disk tilt.

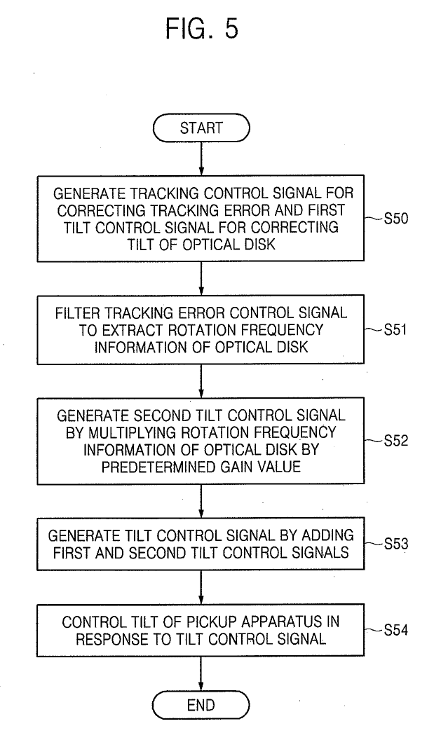

FIG. 5 is a flowchart which explains the method of operating the optical disk drive 100 according to an exemplary embodiment of the present invention. The operational method is now described with reference to FIGS. 1 and 3-5.

The optical disk drive 100 according to an exemplary embodiment of the present invention corrects the tilt of the pickup apparatus 130 generated due to the eccentricity of the optical disk based upon any of the tracking control signal TC or the focusing control signal FC. In particular, FIG. 5, as an example, shows the method of correcting tilt of the pickup apparatus 130 generated due to the eccentricity of the optical disk 130 based upon the tracking control signal TC.

The tracking error correction circuit 143 generates the tracking control signal TC to correct the tracking error TE detected by the servo error detection unit 141. The first tilt correction circuit 146 of the tilt correction circuit 145 generates the first tilt control signal TILT_C1 to correct the tilt of the optical disk (S50).

Then, the second tilt correction circuit 147 of the tilt correction circuit 145 generates the second tilt control signal TILT_C2 to correct tilt of the pickup apparatus 130 generated due to the eccentricity of the optical disk based upon the tracking control signal TC (S51 and S52). The second tilt control signal TILT_C2 is generated as follows.

The first low pass filter 149a of the second tilt correction circuit 147 filters the tracking control signal TC to extract the rotation frequency signal of the optical disk (S51). The first amplifier 150a generates the second tilt control signal TILT_C2 by multiplying the rotation frequency signal of the optical disk by the gain value (S52).

The adder 151 of the second tilt correction circuit 147 adds the first tilt control signal TILT_C1 and the second tilt control signal TILT_C2 to generate the tilt control signal TILT_C (S53). Then, the tilt actuator 135 of the pickup apparatus 130 controls the tilt of the pickup apparatus 130, in response to the tilt control signal TILT_C (S54). As a result, the tilt of the pickup apparatus 130 generated due to the eccentricity of the optical disk and the optical disk tilt may be corrected.

Embodiments of the present invention can include computer readable codes on a computer readable recording medium. The computer readable recording medium is any data storage device that can store data which can be thereafter be read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

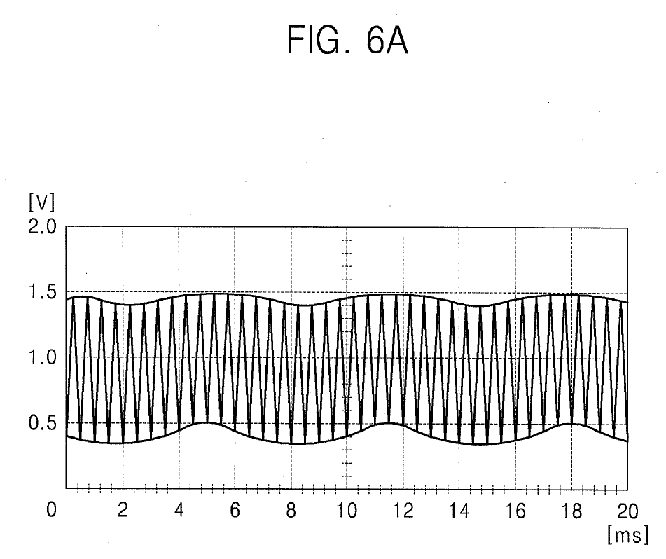

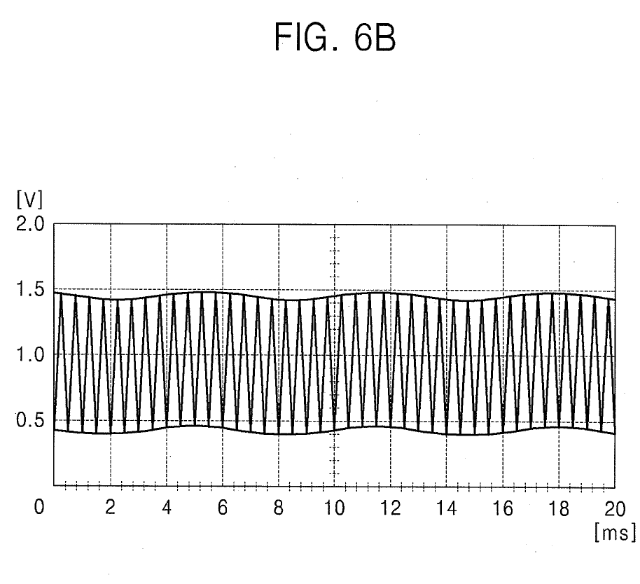

FIG. 6A is a graph showing an RF signal read by a pickup apparatus of an optical disk drive according to a comparative example. FIG. 6B is a graph showing an RF signal read by the pickup apparatus 130 of the optical disk drive 100 according to an exemplary embodiment of the present invention.

Referring to FIG. 6A, it can be seen that an RF drop, that is, a fluctuation in a low portion, is generated, at the same frequency as the rotation frequency of the optical disk, in the RF signal read by a pickup apparatus of an optical disk drive according to the comparative example. In contrast, referring to FIG. 6B, the RF drop is improved in the RF signal read by the pickup apparatus 130 of the optical disk drive 100 according to an exemplary embodiment of the present invention. This signifies that the optical disk drive 100 according to at least one exemplary embodiment of the present invention more accurately performs the recording and reproduction operation as compared to that of the conventional optical disk drive.

As described above, since the optical disk drive according to at least one exemplary embodiment of the present invention is capable of correcting tilt of a pickup apparatus generated due to the eccentricity of an optical disk during the operation of an optical disk drive, read/write operations are more accurately performed.

While exemplary embodiments of the present invention have been particularly shown and described, those skilled in the art would appreciate that various changes in form and details may be made therein without departing from the spirit and scope of the following claims.

What is claimed is:

1. An optical disk drive comprising:
a pickup apparatus that reads data recorded on an optical disk or records encoded data on the optical disk, the pickup apparatus having a servo control unit; and
a servo error correction unit that generates, based upon data read by the pickup apparatus, a tilt control signal that corrects tilt of the pickup apparatus generated as a result of eccentricity of the optical disk and as a result of tilt of the optical disk,
wherein the servo control unit controls the tilt of the optical disk and the tilt of the pickup apparatus in response to the tilt control signal.

2. The optical disk drive of claim 1, wherein the servo error correction unit comprises:
a first tilt correction circuit that corrects the tilt of the optical disk; and
a second tilt correction circuit that corrects the tilt of the pickup apparatus generated as a result of the eccentricity of the optical disk.

3. The optical disk drive of claim 2, wherein:
the first tilt correction circuit generates a first tilt control signal that corrects the tilt of the optical disk, and
the second tilt correction circuit:
generates a second tilt control signal, based upon a tracking error of the pickup apparatus, that corrects the tilt of the pickup apparatus generated as a result of the eccentricity of the optical disk, and
generates the tilt control signal based upon the first tilt control signal and the second tilt control signal.

4. The optical disk drive of claim 3, wherein the second tilt correction circuit comprises:
a tilt control signal generation unit that generates the second tilt control signal based upon the tracking error; and
an adder that generates the tilt control signal by adding the first tilt control signal and the second tilt control signal.

5. The optical disk drive of claim 4, wherein the tilt control signal generation unit comprises:
a filter that filters a tracking control signal that corrects the tracking error and extracts a rotation frequency signal of the optical disk; and
an amplifier that generates the second tilt control signal by multiplying the rotation frequency signal of the optical disk by a gain value.

6. The optical disk drive of claim 5, wherein the gain value is proportional to the amount of tilt of the pickup apparatus.

7. The optical disk drive of claim 2, wherein:
the first tilt correction circuit generates a first tilt control signal that corrects the tilt of the optical disk, and
the second tilt correction circuit:
generates a second tilt control signal, based upon a focusing error of the pickup apparatus, that corrects the tilt of the pickup apparatus generated as a result of the eccentricity of the optical disk, and
generates the tilt control signal based upon the first tilt control signal and the second tilt control signal.

8. The optical disk drive of claim 7, wherein the second tilt correction circuit comprises:
a tilt control signal generation unit that generates the second tilt control signal based upon the focusing error; and
an adder that generates the tilt control signal by adding the first tilt control signal and the second tilt control signal.

9. The optical disk drive of claim 8, wherein the tilt control signal generation unit comprises:
a filter that filters a focusing control signal that corrects the focusing error and extracts a rotation frequency signal of the optical disk; and
an amplifier that generates the second tilt control signal by multiplying the rotation frequency signal of the optical disk by a gain value.

10. The optical disk drive of claim 9, wherein the gain value is proportional to the amount of tilt of the pickup apparatus.

11. The optical disk drive of claim 2, wherein the second tilt correction circuit comprises:
a first filter amplifier circuit that generates a tracking error tilt control signal, based upon a tracking error of the pickup apparatus, that corrects the tilt of the pickup apparatus generated as a result of the eccentricity of the optical disk,
a second filter amplifier circuit that generates a focusing error tilt control signal, based upon a focusing error of the pickup apparatus, that corrects the tilt of the pickup apparatus generated as a result of the eccentricity of the optical disk, and
a switch that selects the first filter amplifier circuit or the second filter amplifier circuit.

12. The optical disk drive of claim 11, wherein the first filter amplifier circuit comprises:
a filter that filters a tracking control signal that corrects the tracking error and extracts a rotation frequency signal of the optical disk; and
an amplifier that generates the tracking error tilt control signal by multiplying the rotation frequency signal of the optical disk by a gain value.

13. The optical disk drive of claim 11, wherein the second filter amplifier circuit comprises:
a filter that filters a focusing control signal that corrects the focusing error and extracts a rotation frequency signal of the optical disk; and
an amplifier that generates the focusing error tilt control signal by multiplying the rotation frequency signal of the optical disk by a gain value.

14. A method of operating an optical disk drive, the method comprising:
generating a tracking control signal that corrects a tracking error and a first tilt control signal that corrects tilt of an optical disk;
filtering a tracking error control signal and extracting rotation frequency information of the optical disk;
generating a second tilt control signal by multiplying the rotation frequency information of the optical disk by a gain value;
generating a tilt control signal by adding the first tilt control signal and the second tilt control signal to provide a combined tilt control signal; and
controlling tilt of the pickup apparatus in response to the combined tilt control signal.

15. The method of operating an optical disk drive of claim 14, wherein an amplifier multiplies the rotation frequency information of the optical disk by the gain value.

16. The method of operating an optical disk drive of claim 15, wherein the gain value is proportional to the amount of tilt of the pickup apparatus.

17. A computer readable recording medium comprising stored instructions, readable by a computer system, that:
generate a tracking control signal that corrects a tracking error and a first tilt control signal that corrects tilt of an optical disk;
filter a tracking error control signal and extracts rotation frequency information of the optical disk;
generate a second tilt control signal by multiplying the rotation frequency information of the optical disk by a gain value;
generate a tilt control signal by adding the first tilt control signal and the second tilt control signal to provide a combined tilt control signal; and
control tilt of the pickup apparatus in response to the combined tilt control signal.

18. The computer readable recording medium of claim 17, wherein an amplifier multiplies the rotation frequency information of the optical disk by the gain value.

19. The computer readable recording medium of claim 18, wherein the gain value is proportional to the amount of tilt of the pickup apparatus.
